(19) United States
(12) Patent Application Publication
(10) Pub. No.: US 2026/0321014 A1
(43) Pub. Date: Oct. 15, 2026

(54) METHOD FOR DETERMINING THE STATUS OF A PIECE GOOD HANDLNG SYSTEM, AND STATUS DETERMINATION SYSTEM

(71) Applicant: Körber Supply Chain Logistics GmbH, Konstanz (DE)

(72) Inventors: Marco Fischer, Konstanz (DE); Richard Huber, Konstanz (DE); Dirk-Udo Eisser, Reichenau (DE); Oliver Schulze, Überlingen (DE); Rolf-Peter Skrdlant, Überlingen (DE)

(21) Appl. No.: 19/549,440

(22) Filed: Feb. 25, 2026

(30) Foreign Application Priority Data
Feb. 26, 2025 (EP) 25160171.2

(51) Int. Cl. G06V 20/52; G06V 10/75; G06V 10/764; G08B 31/00

(52) U.S. Cl. CPC G06V 20/52; G06V 10/751; G06V 10/764; G08B 31/00; G06V 2201/06

(57) ABSTRACT

A method for determining a status of a piece good handling system includes capturing and/or determining image information of a handling area of the piece good handling system, receiving and/or retrieving reference image information from a reference database, and determining a status value based on the image information and the reference image information.

### BACKGROUND OF THE INVENTION

The present disclosure relates to a method for determining a status of a piece good handling system, a computer program, and a status determination system for determining a status of a piece good handling system for handling piece goods.

Current piece good handling systems are designed to recognize and sort piece goods. The status of the piece good handling system is divided into two categories. According to a first category, the status of the piece good handling system is assessed as OK. In this first category, the process currently being performed by the piece good handling system continues to be performed unchanged and the piece good handling system handles the corresponding piece goods. In the second category, the current status of the piece good handling system is considered to be not OK. If the state is recognized as belonging to the second category, the piece good handling system comes to a complete standstill. The piece goods are no longer handled. The piece good handling system emits a warning signal to a user. Only when the user acknowledges the status of the piece good handling system does the piece good handling system resume normal operation. In the current prior art, a status of the piece good handling system is assigned to the second category if, for example, a foreign object that is not a piece good is present in a handling area of the piece good handling system. Such objects that cause a piece good handling system to enter a second status, i.e., that lead to an interruption of the process by the piece good handling system, include various objects, including the hands of users, which also come into the field of vision without actually posing a danger to the process of the piece good handling system. As a result, current piece good handling systems are prone to malfunction and frequent interruptions to the regular processes of the piece good handling system occur. Since this interruption of the piece good handling system can only be acknowledged by the user, a large number of users must be physically present on site to acknowledge the interruption in the piece good handling system and maintain the ongoing operation of a piece good handling system.

Therefore, it is an object of present disclosure to provide a method that allows the determination of a status of a piece good handling system, which reduces the number of interruptions in the ongoing operation of the piece good handling system.

### SUMMARY OF THE INVENTION

According to one aspect of the present disclosure, a method for determining a status of a piece good handling system is provided. In particular, the method comprises capturing and/or determining image information of a handling area of the piece good handling system. In particular, the method comprises receiving and/or retrieving reference image information from a reference database. In particular, the method comprises determining a status value based on the image information and the reference image information. In particular, the handling area comprises the area in which the piece good handling system is set up to manipulate a piece good. In particular, manipulating comprises changing the position of a piece good and/or changing the movement trajectory of a piece good.

Compared to the known prior art, the subject-matter of the present disclosure provides the advantage that a plurality of different status values can be determined by determining a status value and taking into account the image information and the reference image information. The large number of different status values can lead to different actions by the piece good handling system. Thus, it is not necessarily the case that the current operation of the piece good handling system must be interrupted every time a foreign object that is not a piece good is located in its handling area. Instead, the piece good handling system can, for example, slow down or change its planned trajectory in order to avoid the interfering object or prevent any influence of the interfering object on the piece good handling system or the piece goods themselves. Furthermore, a malfunction may only occur when several events occur in combination. This makes it easier to assess events and determine whether it is actually necessary to interrupt the operation of the handling system or whether other measures are sufficient. This enables early detection of malfunction situations. Furthermore, danger to people and materials can be avoided. By using image information, completely new and unexpected malfunction situations can be detected. A malfunction may be due to human intervention in the system (hands, body parts in the image), jamming (e.g., of piece goods), oversized piece goods, extreme throughput peaks, foreign objects that may endanger operation, contamination on the conveyor element, contamination of a vision system (e.g., camera), and/or lighting failure.

The piece good handling system may be a device designed to handle piece goods. In this context, handling may mean that a piece good is physically moved in space, that the orientation of the piece good is changed, and/or that the movement of the piece good is accelerated, slowed down, stopped, or initiated. The piece good handling system may comprise a robot. Furthermore, the piece good handling system may also be a conveyor system or any other system in which image information is available. The piece good may be a postal item. In particular, the piece good may be a parcel, small parcel, polybag, transport bag, shipping roll, letter, or the like. The retrieval step may take place after the first step. The step of determining can take place after the step of retrieving. In particular, the status value reflects a status of the piece good handling system. In particular, the piece good handling system can comprise a controllable robot arm. In particular, a piece good handling system can comprise a sensor for detecting an environment, in particular a handling area, in order to detect the piece good handling system. In particular, the piece good handling system may comprise a control unit. In particular, the piece good handling system may comprise an operating unit. In particular, the piece good handling system may comprise a communication interface. In particular, the control unit is connected to the operating unit for signal exchange. In particular, the control unit is connected to the robot arm for signal exchange. In particular, the control unit is connected to the sensor for signal exchange. In particular, the control unit is connected to the communication interface for signal exchange. In particular, the robot arm is designed to move in at least one spatial direction. In particular, the robot arm is designed to manipulate a piece good in the handling area. In particular, the manipulation comprises changing the position of a piece good and/or changing the movement trajectory of the piece good.

In particular, the communication interface is designed to enable a connection between the control unit and an external computing unit. In particular, the external computing unit is located outside the piece good handling system. In particular, the communication interface is designed to establish a wired and/or wireless connection for signal exchange with the external computing unit. In particular, a handling area is an area in which the handling device is designed to handle piece goods. In particular, handling a piece good comprises gripping and/or lifting and/or moving and/or lowering piece goods.

In particular, image information is determined on a sensor of the piece good handling system. In particular, the sensor of the piece good handling system comprises a camera and/or a sound-based sensor. In particular, the sensor of the piece good handling system comprises an ultrasonic sensor and/or a light barrier. In particular, the camera is designed to operate in visible light. In particular, the camera is designed to operate in infrared light. In particular, the camera is designed to operate in the infrared range, preferably in the near-infrared range. In particular, the camera comprises a fisheye lens. The image information can be used as supplementary information to other sensor data. This provides additional security in the event that other safety systems (light barriers, personal protection light grids or laser scanners, doors, upstream systems, etc.) fail.

In particular, the reference database is set up to contain the reference image information and further reference image information. In particular, the reference database is set up to provide the reference image information. In particular, the reference database is set up to store and/or provide new reference image information. In particular, the reference database is designed as a dynamic memory. In particular, the reference database is stored on the control unit of the piece good handling system. In particular, the reference database is stored on an external computing unit. In particular, the control unit is set up to exchange signals with the external computing unit via the communication interface and to access the reference database. The status of the piece good handling system can be indicative of a warning level. In other words, the status can be an operating status of the piece good handling system. For example, the status can indicate that everything is OK. Furthermore, the status can indicate that something has been detected (e.g., a user in the detection area of the piece good handling system) but that this does not affect operation or anything else, which is why the operation of the piece good handling system is continued. In addition, the status may indicate that the operation of the piece good handling system must be interrupted. This status may also occur, for example, when an object or a person is moving toward the handling area and will cause problems there. In other words, the piece good handling system can be controlled accordingly in preparation for a status that is about to occur. This can even increase safety. The image information can be image data. The image information can comprise an area around the piece good handling system, in particular a handling area of the piece good handling system. The image information can comprise features. Features can be certain things that are of interest. For example, an immovable part of the piece good handling system may not be comprised in the image information. This allows the size of the image information to be reduced, which can speed up the process. Thus, the image information can be determined from raw image data, which is, for example, an RGB image or an image data stream. The reference database may comprise reference image information. The reference image information may be features that have occurred in the past in connection with the piece good handling system. For example, the reference image information may comprise as a feature a body part of a user in the handling area. By retrieving the reference image information, a captured object (e.g., feature in the image information) can be identified. In addition, the reference image information may comprise further information, such as information about past events when a particular feature has occurred before. This allows further information to be taken into account during the determination step. When determining the status value, the reference image information can then be used together with the image information to determine a status value. The image information may also comprise metadata such as time, date, machine power, position of the piece good and/or other features, or other measured values from the piece good handling system. The image information can therefore be evaluated using the information retrieved from the reference database. This allows an accurate status value to be determined. The image information and the reference image information are used as input information when determining the status value. This allows a status value that is close to reality to be determined. Furthermore, the method may comprise comparing all reference image information in the reference database with the image information in order to determine the matching reference image information. Individual features from the image information can be used as a basis for this. This allows the reference image information that matches the image information to be found precisely. Several reference image information may also match an image information. This provides a learning effect. In other words, this means that the more reference image information is available, the better the status value can be determined. Overall, the status value can be used to create a value that indicates precisely to what extent certain events in the vicinity of the piece good handling system can or cannot affect the operation of the piece good handling system. Based on this, measures can then be taken to intervene in the operation of the piece good handling system.

Optionally, the image information comprise piece good information that is indicative of the properties of a piece good. Piece good information can comprise shape, weight, surface texture, sender, recipient, or the like. Thus, the condition of piece goods can be taken into account in the image information and in determining a status value.

Optionally, a piece good is an object that is to be regarded by the piece good handling system as an object to be handled. Thus, piece goods can be understood to mean goods that are actually handled by the piece good handling system. Furthermore, only objects relevant to the determination of a status value of the status of the piece good handling system can be taken into account.

Optionally, the image information comprise foreign object information, which contains information about a foreign object. This means that foreign object information, which may include information about objects that could interfere with the operation of the piece good handling system, can be taken into account when determining a status value for the piece good handling system. Furthermore, a more precise status value of the piece good handling system can be determined.

Optionally, a foreign object is an object that is located in the handling area of the piece good handling system. In other words, the foreign object can be an object that is not normally found in the handling area of the piece good handling system. This means that only objects that are not normally found in the handling area of the piece good handling system can be taken into account. This can reduce the amount of data. Optionally, the reference image information contains information about a piece good. Optionally, the reference image information contains information about a foreign object.

Optionally, the determination comprises a comparison of features from the image information and the reference image information. This means that only certain areas of the image information and the reference image information can be compared. For example, it is conceivable that only the relative position of the piece goods in relation to each other is compared. In other words, only certain properties of the image information and the reference image information can be compared. This can speed up the determination step, as only certain properties are compared. Properties that are critical in terms of susceptibility to malfunction can be used here. Examples of such properties include piece good size, piece good position relative to each other, piece good position relative to elements of the piece good handling system, movement speed, etc.

Optionally, the reference database comprises reduced reference image information. In other words, the reference image information in the reference database may only comprise an area of interest. This saves storage space and speeds up access times. It is also conceivable that the reference image information only has properties that are compared with the image information (see also above). This further reduces the amount of storage space required.

Optionally, determining the status value comprises comparing image information and reference image information to determine a degree of deviation of image information from reference image information and determining the status value based thereon. In other words, the comparison can be used to calculate the probability of whether the scene shown (which is comprised in the image information) is within a normal variation range or whether an exceptional situation may exist, characterized by very high deviations, in particular from image properties. A normal variation can be understood to mean that a deviation from the image information to the reference image information is within an acceptable range in which there is an increased probability that no disturbance will occur. The acceptable range can be adjusted based on empirical values. Furthermore, several ranges can also be defined in which individual information can be output, for example, to warn a user. See also the reference classes below.

The determination can be carried out using a learning algorithm. Reference images of different states can be used to train the learning algorithm so that each state is mapped to a position in a vector space in which similar states are close to each other in a metric to be defined. New images to be classified can also be mapped to a point in the vector space, and proximity to known statuses can be used to determine whether it is one of the known statuses or whether it could be a completely new, unknown class. In this way, the learning algorithm can be further trained to learn new statuses. In this case, the status of humans can be classified so that in the next training session, the distance to known statuses must be minimized or maximized, depending on whether the status can be assigned to a known class or whether a new class should be created.

Optionally, the status value can be determined by a learning algorithm. The learning algorithm can thus have the image information as input information and the status value as output. The learning algorithm can be trained to output the current status based on image information. This status can then be output in the form of the status value. The learning algorithm can thus be trained to recognize statuses based on image information. The learning algorithm can be a neural network. Variables can be adjusted when training the learning algorithm. After training, the status can then be determined based solely on the image information and the variables of the learning algorithm. This means that known anomalies, for example, can be learned. An anomaly could be, for example, a lighting failure. Based on this, the status value can be determined, and the importance or consequences of a detected anomaly can be determined. This provides a method that can adapt to changing boundary conditions.

For example, if a malfunction or anomaly occurs, it can be acknowledged by a user. This provides the learning algorithm with information about the initial situation that led to the malfunction. This allows the learning algorithm to evolve. In other words, the learning algorithm can be trained with this information without a clear assignment of the stored data (reference image information) to individual images (image information) being recognizable. For example, the handling system can only continue its work after acknowledgment by a user after it has been stopped by a malfunction. For acknowledgment, a classification of the event (i.e., the malfunction) can be entered in order to be able to transmit recommendations for action or various escalation levels to the control system for future comparable events. This allows the learning algorithm to be further trained. Image information and acknowledgment information (e.g., as reference image information) can be collected centrally and made available to various handling systems. This allows a learning algorithm to be used even with new systems.

Optionally, the piece good handling system is controlled based on the image information. In other words, the image information is used to control the piece good handling system and not exclusively for fault detection. This means that image information that is available anyway can be used to provide additional functionality. No additional camera technology is required; instead, images that are processed anyway can be examined for further characteristics.

Optionally, the image information is generated from a raw image data stream, wherein only every n^{th} or n-th image is used for the image information. For example, every 2nd to every 30th image can be used. In other words, not every image captured can be included in the image information. This allows the amount of data to be reduced without losing essential information. The number chosen for the variable n may depend on the speed at which the piece goods are handled. If the piece goods are handled at high speed, a low value for n can be chosen. This means that only every n-th image needs to be examined in order to save computing time. Furthermore, several consecutive images can also be examined to detect dynamic malfunctions, e.g., the conveyor element is moving, but the piece goods on it are not. This provides a reliable determination of the status value. Furthermore, the image information can also be taken into account over time. For example, image information can be generated from the raw image data stream at a specific time interval. It is conceivable that image information could be extracted every minute. Other time intervals are also conceivable, depending on the resolution of the raw image data stream. In general, a time interval of a few seconds to several hours is conceivable. In addition, image information can also be extracted from the raw image data stream based on other parameters. For example, image data information can be extracted every 100 m of conveyor belt distance (of a conveyor device). This allows a handling device to be monitored depending on the conveyor speed. Values from 1 m to 1000 m are also conceivable here, depending on the density of the conveyor device.

Optionally, when determining the image information, part of the image and/or part of an image series can be disregarded. This allows the image information to be reduced to the essential information required to determine a status value. Furthermore, the amount of data to be processed can be reduced. As a result, the processing speed can be increased. This also reduces the time required to determine the status value.

Optionally, the determination of the image information is based on sensor data from the sensor of the piece good handling system. In other words, the image information can be determined by at least one sensor of the piece good handling system. In other words, a sensor of the piece good handling system can be used. Therefore, a sensor that is already present (e.g., used to control the piece good handling system) can also be used to determine the image information. This means that no additional sensor needs to be provided on the piece good handling system to perform the method.

Optionally, determining the image information comprises selecting an area of interest. In particular, the image information can be limited to this area of interest. The remaining information can be omitted so that it is not taken into account when determining the image information. This reduces the amount of data. This allows faster processing of the image information.

Optionally, an area of interest comprises the piece goods. This allows the data rate to be processed to be reduced and, at the same time, a piece good to be handled to be taken into account in the determination of the status value. This increases the reliability of the determination of the status value as an indicator of the actual status of the system.

Optionally, the piece good handling system has a conveyor. A conveyor can be a conveyor belt, roller conveyor, or other conveyor device. The piece goods can thus be transported to the piece good handling system.

Optionally, the area of interest comprises at least a section of the conveyor. Consequently, the status value can be indicative of a status of the piece good handling system and all essential connected elements. Since the conveyor causes the piece goods to move, further conclusions can be drawn from an additional observation of the conveyor.

Optionally, the area of interest comprises an intermediate storage area. The intermediate storage area can be an area in which a piece good is temporarily stored, in particular not currently being transported. Optionally, the intermediate storage area is designed as a storage surface, in particular for the piece good.

Optionally, the image information comprises an image series. This allows more information about the same piece good to be obtained. Furthermore, changes in boundary conditions or characteristics can thus be taken into account.

Optionally, the image and/or image series is determined by means of the sensor of the piece good handling system. Consequently, no additional sensor needs to be provided for the method. Instead, the sensor of the piece good handling system can be used, which is already provided for the operation of the piece good handling system. This reduces the manufacturing cost of a piece good handling system that would be suitable for carrying out this method.

Optionally, the image series comprises a first image, which was captured at a first point in time, and a second image, which was captured at a second point in time that differs from the first point in time. Thus, by evaluating the first image and the second image, more information can be obtained than from the first image or the second image alone. In other words, the image series can be designed as a video. This can simplify the evaluation, in particular the subsequent evaluation, of the image series by a user. Furthermore, a dynamic property of a piece good and/or object can be derived from the first image and the second image. This allows a more precise determination of the status value as an indicator of the actual status of the piece good handling system.

Optionally, the determination of the image information comprises a determination of a motion vector, in particular based on the image series, of a piece good. By determining the motion vector, a motion trajectory of a piece good along a conveyor and/or during handling by the piece good handling system can be obtained. This allows a future path to be determined that the piece good and/or the object will take. Consequently, any collisions can be predetermined, for example.

Optionally, part of the image or part of the image series may be disregarded when determining the status value. In other words, only part of the available image data may be used. For example, only every second image may be used. However, it is also conceivable that only every fifth image is used. This can significantly reduce the amount of data. Consequently, the efficiency of the method for determining the status value can be increased.

Optionally, the position of a piece good can be determined when determining the image information. In particular, reference image information comprises the position of a piece good. This also allows a possible future position of the piece good to be calculated. Optionally, the position of a piece good can be taken into account when determining the status value. Similarly, the position of a foreign object can be determined when determining the image information. For example, reference image information may comprise a position of a foreign object and/or piece good. This can be used to create an indication of what will happen next depending on the position of an object. For example, a piece good that is very close to the edge of a conveyor may fall off the conveyor as it continues to move. Optionally, the position of a foreign object is taken into account when determining the status value.

Optionally, when determining the image information, the distance between a foreign object and a piece good is determined. The distance can be used to infer possible problems or hazards. In particular, reference image information comprises the distance between a foreign object and a piece good. This makes it easy to assign image information to reference image information. This allows a more precise status value to be determined. When determining the status value, the distance between a foreign object and a piece good can be taken into account. Furthermore, when determining the status value, the distance between a foreign object and/or the piece good and the piece good handling system can be taken into account.

Optionally, the status value is a probability value. In particular, the probability value is indicative of the probability with which a foreign object, in particular, may cause a malfunction in the operation of the piece good handling system. This makes it possible to specify the probability of problems or defects occurring in the piece good handling system in the future. By specifying probabilities, a subdivision can be made as to how likely it is that problems will occur. A malfunction can be a malfunction of the handling system. For example, a malfunction occurs when a piece good unintentionally collides with the piece good handling system. Furthermore, a malfunction can occur when a piece good is unintentionally moved to any position (for example, when a piece good falls from a conveyor). A malfunction can also occur if the piece good handling system collides with a foreign object (e.g., with a user or parts of a user). In the event of a malfunction, operation must be interrupted or at least one user must intervene manually. For example, a malfunction caused by a foreign object comprises causing a jam of piece goods, in particular caused by a foreign object. Optionally, the malfunction caused by a foreign object comprises vertical positions of a piece good, in particular caused by a foreign object. Optionally, the malfunction comprises damage to piece goods, in particular by a foreign object. Optionally, the malfunction comprises double and multiple packing of piece goods, in particular caused by a foreign object. Furthermore, the malfunction may comprise a piece good getting stuck due to a foreign object. Optionally, the malfunction caused by a foreign object comprises an obstruction of the movement of the piece good handling system and/or an impairment of the handling area, in particular a section of the field of view in which a piece good is located, of a sensor.

Optionally, the status value can assume a first status characteristic, a second status characteristic, and a third status characteristic. In particular, the first status characteristic, the second status characteristic, and the third status characteristic are different. Consequently, the status value can be divided into different classes. This allows the same remedy to be provided for a group of status values. This makes it easier to design responses to a change in status. It is conceivable to introduce a traffic light system in which the status of the piece good handling system is designated as OK up to a certain status value. If the status value changes beyond this, a warning can be issued. If the status value changes further, immediate countermeasures can be required.

Optionally, when determining the status value, only an area of interest in the reference image information and/or an area of interest in the image information is taken into account. In particular, when determining the status value, an area that is not of interest in the image information and the reference image information is not taken into account. This reduces the effort required to determine the status value. Furthermore, the precision of the determined status value is maintained.

Optionally, the reference image information comprise a first reference class, a second reference class, and a third reference class. In particular, the first reference class, the second reference class, and the third reference class are different. In particular, the determination of the status value of the first reference class, the second reference class, and the third reference class is based on the reference image information. In particular, the first reference class and/or the second reference class and/or the third reference class are taken into account when determining the status value.

Optionally, when determining the status value, the ratio in which the image information of the first reference class and/or the second reference class and/or the third reference class is to be assigned is determined. In particular, the status value is determined depending on the distribution of the image information in the first reference class, in the second reference class, and in the third reference class.

Optionally, the reference image information comprise an evaluation of the first reference class and/or the second reference class and/or the third reference class. In particular, the evaluation of the first reference class and/or the second reference class and/or the third reference class is taken into account when determining the status value.

Optionally, the status value is determined using a learning algorithm. This allows experience gained to be taken into account. If, for example, the type of piece goods changes, a learning algorithm can collect experience gained and thus adapt independently to new piece goods. The learning algorithm can, for example, observe which characteristics and/or which relative relationship between the characteristics leads to problems. This ensures continuous further development.

Optionally, the method also includes a step in which the piece good handling system is controlled depending on the status value of the piece good handling system. This allows the piece good handling system to react to external influences based on the determined status value.

Optionally, the method includes a step comprising outputting the status value to an operating unit and/or a communication unit. In particular, the method includes a step comprising receiving and/or retrieving an evaluation by a user via the operating unit and/or the communication interface. In particular, the method comprises in a step outputting the image information of the associated evaluation to the reference database. A user's evaluation of a status of the piece good handling system can be entered into the reference database. Furthermore, an evaluation of the status of the piece good handling system by the user can be taken into account in a subsequent determination of the status value of the piece good handling system. Furthermore, the same and/or similar image information may lead to a different status value as a result of the evaluation recorded by the user. Optionally, the output to the user is visual and/or haptic and/or auditory. The output of the warning to the user can be easily perceptible to the user.

Optionally, the operating unit and/or the communication interface is set up to receive inputs from a user. In particular, such an input may comprise acknowledgment of an input by the user and/or evaluation of a status value of the piece good handling system. This allows for simple input by the user. This lowers the inhibition threshold for a user to make an input and allows faster acknowledgment of a warning by the piece good handling system and/or thus increases the number of evaluations of a status value. The latter can increase the quality of the status value as an indicator of the probability with which a status of the piece good handling system is present.

Optionally, if the first state characteristic is present, a previously planned movement sequence of the piece good handling system remains unaffected. In other words, this means that the planned handling of piece goods and/or the regular operation of the piece good handling system remains unchanged as a result of the determination that the status value has the first status characteristic. Thus, in a state of the piece good handling system that is assessed as non-critical, regular operation of the piece good handling system can be maintained. This can reduce the need for manual intervention by a user to continue operating the piece good handling system.

Optionally, if the second state characteristic is present, a previously planned movement sequence of the piece good handling system is implemented in a modified form. In other words, this means that the regular sequence is adjusted by a corrected sequence of operation of the piece good handling system. This avoids further intervention by a user for the operation of the piece good handling system. This reduces personnel requirements.

Optionally, if the third state characteristic is present, the piece good handling system stops, in particular immediately. In other words, if it is determined that the status value has the third state characteristic, the regular operation of the piece good handling system is immediately terminated. In particular, a warning is issued to the user. In particular, the warning is issued via the operating device. Thus, critical conditions that exceed a safety criterion can still lead to a shutdown of the operation of the piece good handling system. This ensures that the safety of operation is maintained during the operation of a piece good handling system.

Optionally, the method further includes a step of issuing a warning to the user via the operating unit and/or the communication interface when the piece good handling system stops. In particular, the method includes a step of receiving an enable signal from the user via the operating unit and/or the communication interface. In particular, the method includes a step of resuming regular operation of the piece good handling system upon receipt of the release from the user. Thus, a condition of the piece good handling system that is assessed as critical by the method can be presented to a user for evaluation. This can increase the safety of the method.

According to a further aspect of the present disclosure, a method is provided for training or retraining a learning algorithm for determining a status of a piece good handling system for piece goods. In particular, the method comprises, in one step, receiving input training data, namely evaluated images of the piece good handling system during a period of time, wherein the images are provided sequentially in ascending time order. In particular, the method comprises, in one step, receiving output training data, namely a status value of the piece good handling system for piece goods during the period of time. In particular, the method comprises, in one step, training or retraining the learning algorithm based on the input training data and the output training data. An advantage of this embodiment may be that a more precise status value of the piece good handling system can be determined by means of the learning algorithm. Receiving output training data, namely at least one status value. The training may be initial training of a learning algorithm or retraining of an existing learning algorithm. Variables within the learning algorithm can be adjusted so that input training data matches the output training data. The variables can effect or influence the transformation of the input data into the output data. Once the variables have been adjusted (i.e., the learning algorithm has been trained), a status value can be output when image information is entered. A learning algorithm that is in use can also be further trained during operation by marking incorrect outputs as such and adjusting the variables of the learning algorithm accordingly.

According to a further aspect of the present disclosure, a computer program is provided. The computer program comprises, in particular instructions which, when the program is executed by a computing unit, cause the computing unit to execute the method according to one of the previous embodiments.

The disclosure also relates to a computer-readable medium containing instructions which, when executed by a computing unit, cause the computing unit to perform the above method. Such a computer-readable medium may be any digital storage medium, for example, a hard disk, a server, a cloud or a computer, an optical or magnetic digital storage medium, a CD-ROM, an SSD card, an SD card, a DVD, or a USB or other memory stick.

According to a further aspect of the present disclosure, a condition determination system is provided for determining a piece good handling system for handling piece goods. In particular, the condition determination system comprises a control unit which is arranged to execute a method according to one of the previous embodiments.

### BRIEF DESCRIPTION OF THE DRAWINGS

Preferred embodiments of the subject matter of the present disclosure are described below with reference to the accompanying figures.

FIG. 1 is a schematic representation of a piece good handling system according to an embodiment of the present disclosure;

FIG. 2 is a schematic representation of a piece good handling system according to an embodiment of the present disclosure;

FIG. 3 is a schematic representation of a piece good handling system with an intermediate storage facility according to an embodiment of the present disclosure;

FIG. 4 is a schematic flowchart of a method according to an embodiment of the present disclosure;

FIG. 5 is a schematic flowchart of a method according to an embodiment of the present disclosure;

FIG. 6 is a schematic flowchart of a method according to an embodiment of the present disclosure;

FIG. 7 is a schematic representation of a method according to an embodiment of the present disclosure; and

FIG. 8 is a schematic method for training or retraining a learning algorithm according to an example of the present disclosure.

### DETAILED DESCRIPTION OF THE PREFERRED EMBODIMENTS

FIG. 1 shows a schematic representation of a piece good handling system 100 according to an embodiment of the present disclosure and a handling area 200 of the piece good handling system 100. The piece good handling system 100 may be located in a factory hall and/or a logistics center in which piece goods are sorted and moved (i.e., handled). The handling area 200 comprises the area in which the piece good handling system 100 is set up to manipulate a piece good.

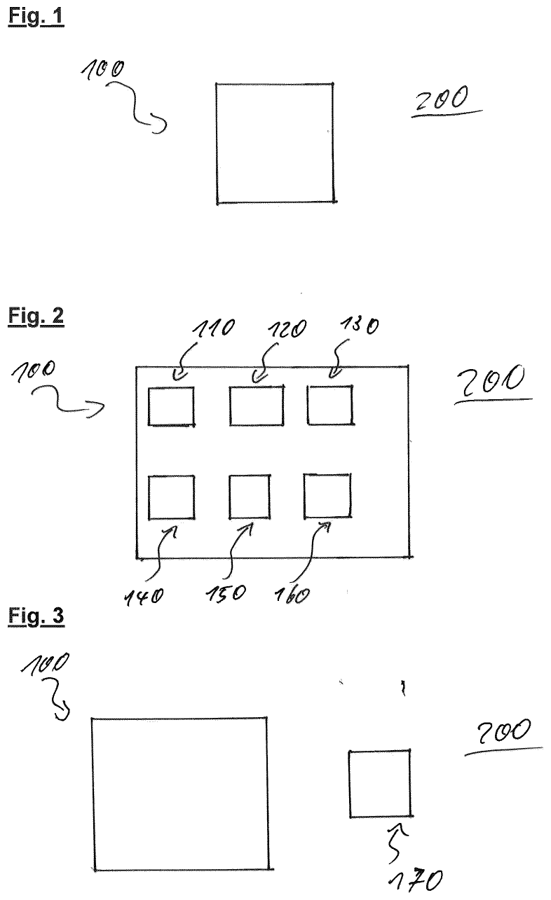

FIG. 2 shows a schematic representation of a piece good handling system according to an embodiment of the present disclosure. The piece good handling system 100 comprises a controllable robot arm 120, a sensor 130 for detecting an environment around the piece good handling system 100, a control unit 110, an operating unit 140, a communication interface 150, and a conveyor 160. The control unit 110 is connected to the operating unit 140, the robot arm 120, the sensor 130, and/or the communication interface 150 for signal exchange. The robot arm 120 is designed to move in three different spatial directions. The robot arm 120 is designed to manipulate a piece good in the vicinity of the piece good handling system. Manipulating a piece good comprises changing the position of a piece good and/or changing the movement trajectory of a piece good.

The communication interface 150 is set up to enable a connection between the control unit 110 and an internal or external computing unit. The external computing unit is located outside the piece good handling system. The communication interface 150 is set up to establish a wireless connection for signal exchange with the external computing unit. The sensor 130 of the piece good handling system 100 comprises a camera, a switch-based sensor, in particular an ultrasonic sensor, and a light barrier. The camera is set up to operate in visible light, in the infrared range, and in the near-infrared range. The camera has a fisheye lens. The control unit 110 is set up to exchange signals with the external computing unit via the communication interface and to access the reference database.

FIG. 3 shows a schematic representation of a piece good handling system 100 according to an embodiment of the present disclosure, with a buffer storage 170 in a handling area 200 of the piece good handling system 100.

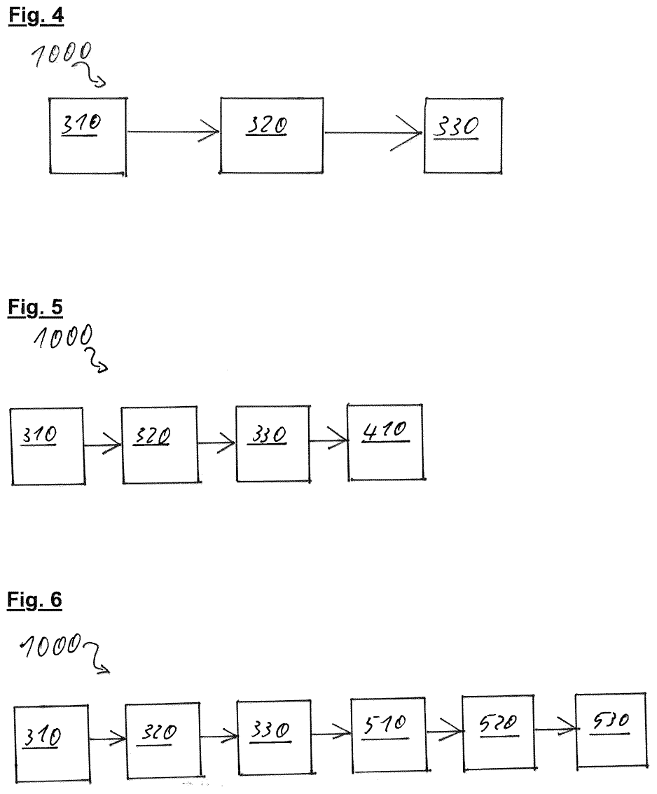

FIG. 4 shows a schematic flowchart of the method 1000 for determining a status of a piece good handling system 100 according to a first embodiment of the present disclosure. The method 1000 comprises, in a first step, composing and/or determining 310 image information of a handling area 200 of the piece good handling system 100. The method comprises, in a second step 320, receiving and/or retrieving reference image information from a reference database. The method 1000 comprises, in a third step, determining 330 a status value based on the image information and the reference image information. The second step 320 is performed after the first step 310. The third step 330 is performed after the second step 320.

The image information comprise piece good information, which contains information about a piece good. A piece good is an object that is to be regarded by a piece good handling system 100 as an object to be handled. The image information comprises foreign object information, which contains information about a foreign object. A foreign object is an object that is a piece good. A foreign object is an object that is to be regarded by a piece good handling system 100 as an object that is located in the handling area 200. The reference image information include reference information about a piece good. The reference image information include reference information about a foreign object.

When determining the image information, part of the image and/or part of an image series is taken into account. The determination of the image information is based on sensor data from the sensor 130 of the piece good handling system 100. The determination of the image information comprises selecting an area of interest. The area of interest comprises a piece good. The area of interest comprises a section of the conveyor. The area of interest comprises a buffer storage. The conveyor is set up to transport the piece good. In particular, the conveyor has a conveyor chute.

The image information include an image series. The image series comprises a first image taken at a first point in time and a second image taken at a second point in time different from the first point in time.

Determining 310 the image information comprises determining a motion vector of a piece good. The motion vector is determined based on the first image and the second image. When determining 330 the status value, part of the image and/or part of the image series is not taken into account. When determining 310 the image information, a position of a piece good is determined. When determining 330 the status value, the position of a piece good is taken into account. When determining 310 the image information, a position of a foreign object is determined. When determining 330 the status value, the position of a foreign object is taken into account. When determining 310 the image information, a distance of a foreign object from a piece good is determined. When determining 310 the image information, a distance of a foreign object from the piece good handling system is determined. When determining 330 the status value, the distance of a foreign object from the piece good handling system is taken into account. When determining 310 the image information, a distance of a piece good from the piece good handling system is determined. When determining 330 the status, the distance of a piece good from the piece good handling system 100 is taken into account.

The status value is a probability value. The probability value is indicative of the probability with which a foreign object can cause a malfunction in the operation of the piece good handling system 100. A malfunction is understood to be an obstacle that hinders the operation of the piece good handling system 100. The malfunction caused by a foreign object comprises the causing of a jam of piece goods by a foreign object.

The status value is a probability value. The probability value indicates the probability with which a foreign object can cause a malfunction in the operation of the piece good handling system 100.

A malfunction is defined as an obstacle or event that hinders the operation of the piece good handling system 100. A malfunction caused by a foreign object comprises causing a jam of piece goods by a foreign object. A malfunction caused by a foreign object comprises a piece good being placed vertically by a foreign object. The malfunction comprises damage to piece goods by a foreign object. The malfunction comprises double and multiple packing of piece goods by a foreign object. The malfunction comprises the piece goods falling due to a foreign object. The malfunction comprises the piece goods getting stuck due to a foreign object. The malfunction comprises liquids being spilled on the piece good handling system 100 due to a foreign object. The malfunction comprises the movement of the piece good handling system being obstructed by a foreign object. The malfunction comprises a foreign object interfering with the handling area 200, in particular a section of the field of view in which a piece good is located, of a sensor 130.

The status value can assume a first state characteristic, a second state characteristic, and a third state characteristic. When determining 330 the status value, only an area of interest in the reference image information and an area of interest in the image information are taken into account. The reference image information comprise a first reference class, a second reference class, and a third reference class. When determining the status value, the first reference class, the second reference class, and the third reference class are taken into account. When determining 330 the status value, the ratio of the image information in the first reference class, the second reference class, and the third reference class is determined. The determination 330 of the status value is made depending on the distribution of the image information in the first reference class, the second reference class, and the third reference class. The reference image information comprises an evaluation of the first reference class, the second reference class, and the third reference class. When determining 330 the status value, the evaluation of the first reference class, the second reference class, and the third reference class is taken into account. The determination 330 of the status value is performed using a learning algorithm.

FIG. 5 shows a schematic flowchart using a method 1000 according to an embodiment of the present disclosure. The method according to the embodiment has similar features to the method from the previous embodiment. The method 1000 comprises, in a fourth step 410, controlling the piece good handling system 100 depending on the status value. The fourth step 410 follows the third step 330.

FIG. 6 shows a schematic flowchart of a method 1000 according to an embodiment of the present disclosure. The method 1000 according to the embodiment has similar features to the method according to the embodiments explained in connection with FIG. 4 or 5.

The method comprises, in a fifth step 510, outputting the status value to an operating unit 140 and to a communication interface 150. The method comprises, in a sixth step 520, receiving and/or retrieving an evaluation by a user via the operating unit and/or the communication interface 150. The method comprises, in a seventh step, outputting 530 the image information and the associated evaluation to the reference database. The sixth step 520 follows the fifth step 510. The seventh step 530 follows the sixth step 520. The output to the user is visual.

If the first state characteristic is present, the previously planned movement sequence of the piece good handling system remains unaffected. If the second state characteristic is present, a previously planned movement sequence of the piece good handling system 100 is implemented in a modified form. If the third state characteristic is present, the piece good handling system 100 comes to a standstill, in particular immediately.

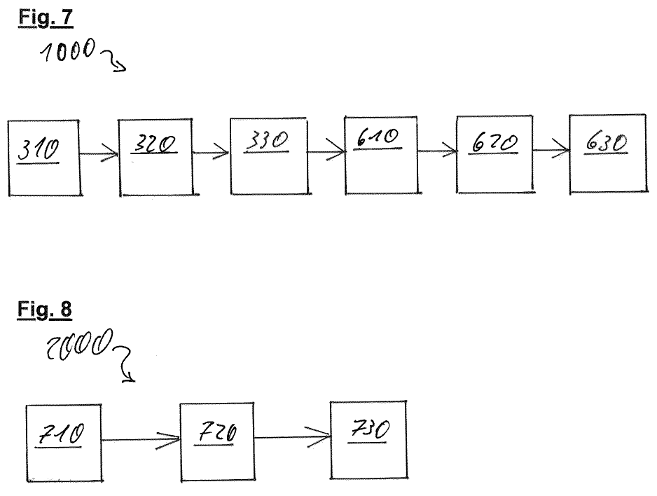

FIG. 7 shows a flowchart of a method 1000 according to an embodiment of the present disclosure. The method 1000 according to the embodiment has similar features to the method 1000 according to one of the previous embodiments. The method 1000 comprises, in an eighth step 610, dispensing a product to the user via the operating unit and/or the communication interface when a piece good handling system 100 comes to a standstill. The method 1000 comprises, in a ninth step 620, receiving an authorization from the user via the control unit and via the communication interface. The method comprises, in a tenth step 630, resuming the regular operation of the piece good handling system 100 when the user has given approval. The ninth step 620 follows the eighth step 610. The tenth step 630 follows the ninth step 620.

FIG. 8 shows a schematic flowchart of a method 2000 for training or retraining a learning algorithm to determine a state of the piece good handling system 100 for piece goods. The method 2000 for training or retraining a learning algorithm for determining a status of a piece good handling system 100 comprises an eleventh step 710, a twelfth step 720, and a thirteenth step 730. The eleventh step 710 includes receiving input training data, namely evaluated images of the piece good handling system 100 during a period of time, wherein the images are provided in descending time order, consecutively. The twelfth step 720 comprises receiving output training data, namely a status value of the piece good handling system 100 for piece goods during the time period. The thirteenth step 730 comprises training or retraining the learning algorithm based on the input data and the output training data. The twelfth step 720 follows the eleventh step 710. The thirteenth step 730 follows the twelfth step 720.

### LIST OF REFERENCE SIGNS

100 Piece good handling system
110 Control unit
120 Robot arm
130 Sensor
140 Operating unit
150 Communication interface
160 Conveyor
170 Buffer storage
200 Handling area
310 First step
320 Second step
330 Third step
410 fourth step
510 Fifth step
520 Sixth step
530 Seventh step
610 Eighth step
620 Ninth step
630 Tenth step
710 Eleventh step
720 Twelfth step
730 Thirteenth step
1000 Method

The invention claimed is:

1. A method for determining a status of a piece good handling system, comprising:
capturing or determining image information of a handling area of the piece good handling system;
retrieving reference image information from a reference database; and
determining a status value based on the image information and the reference image information.

2. The method according to claim 1, wherein determining the status value includes comparing features from the image information and the reference image information.

3. The method according to claim 2, wherein the reference database comprises reduced reference image information.

4. The method according to claim 3, wherein determining the status value includes comparing image information and reference image information to determine a degree of deviation of image information from reference image information and determining the status value based thereon.

5. The method according to claim 4, wherein determining the status value is performed by a learning algorithm.

6. The method according to claim 5, wherein the piece good handling system is controlled based on the image information.

7. The method according to claim 6, wherein the image information is generated from a raw image data stream, and wherein only every n^{th} image is used for the image information.

8. The method according to claim 1,
wherein the image information comprising an image series,
wherein the image series comprises a first image captured at a first point in time and a second image captured at a second point in time different from the first point in time,
wherein determining the image information comprises determining a motion vector of a piece good, and
wherein the status value is determined taking into account the motion vector of a piece good.

9. The method according to claim 1, wherein a part of the image and/or a part of the image series is disregarded when determining the status value.

10. The method according to claim 1, wherein the status value is a probability value, and wherein the probability value is indicative of a probability with which a malfunction may occur in the operation of the piece good handling system.

11. The method according to claim 1,
wherein the reference image information comprises a first reference class, a second reference class, and a third reference class, and/or wherein, when determining the status value, the first reference class, the second reference class, and the third reference class are determined based on the reference image information, and
wherein the first reference class, the second reference class, and the third reference class are taken into account when determining the status value.

12. The method according to claim 1, further comprising:
outputting the status value to an operating unit and/or a communication interface;
receiving and/or retrieving a rating by a user via the operating unit and/or the communication interface; and
outputting the image information and the associated rating to the reference database.

13. The method according to claim 1, further comprising:
outputting a warning to the user via an operating unit and/or the communication interface when the piece good handling system detects an error during operation; and
receiving an approval from the user via the operating unit and/or the communication interface.

14. The method according to claim 1, wherein the reference database comprises reduced reference image information.

15. The method according to claim 1, wherein determining the status value includes comparing image information and reference image information to determine a degree of deviation of image information from reference image information and determining the status value based thereon.

16. The method according to claim 1, wherein determining the status value is performed by a learning algorithm.

17. The method according to claim 1, wherein the piece good handling system is controlled based on the image information.

18. The method according to claim 1, wherein the image information is generated from a raw image data stream, and wherein only every nth image is used for the image information.

19. A computer program comprising instructions which, when executed by a computing unit, cause the computing unit to perform the method according to claim 1.

20. A condition determination system for determining a condition of a piece good handling system for handling postal items, comprising:
a control unit configured to execute a method according to claim 1.
